(19) United States
(12) Patent Application Publication
(10) Pub. No.: US 2008/0018717 A1
(43) Pub. Date: Jan. 24, 2008

(54) Transfer station

(75) Inventors: Thomas G. Cocklin, Portland, OR (US); Steve O. Rasmussen, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/490,579

(22) Filed: Jul. 21, 2006

(51) Int. Cl. B41J 2/175

(52) U.S. Cl. 347/85

(57) ABSTRACT

Various methods and apparatus relating to transferring fluid to a fluid supply of an inkjet print head are disclosed.

### BACKGROUND

Large volume inkjet printers use large volumes of ink. Refilling ink reservoirs of such printers may be time consuming, may substantially interrupt printing and may be prone to error.

### BRIEF DESCRIPTION OF THE DRAWINGS

FIG. 1 is a schematic illustration of a printing system including a printer and a transfer station according to an example embodiment.

FIG. 2 is a schematic illustration of the transfer station of FIG. 1 according to an example embodiment.

### DETAILED DESCRIPTION OF THE EXAMPLE EMBODIMENTS

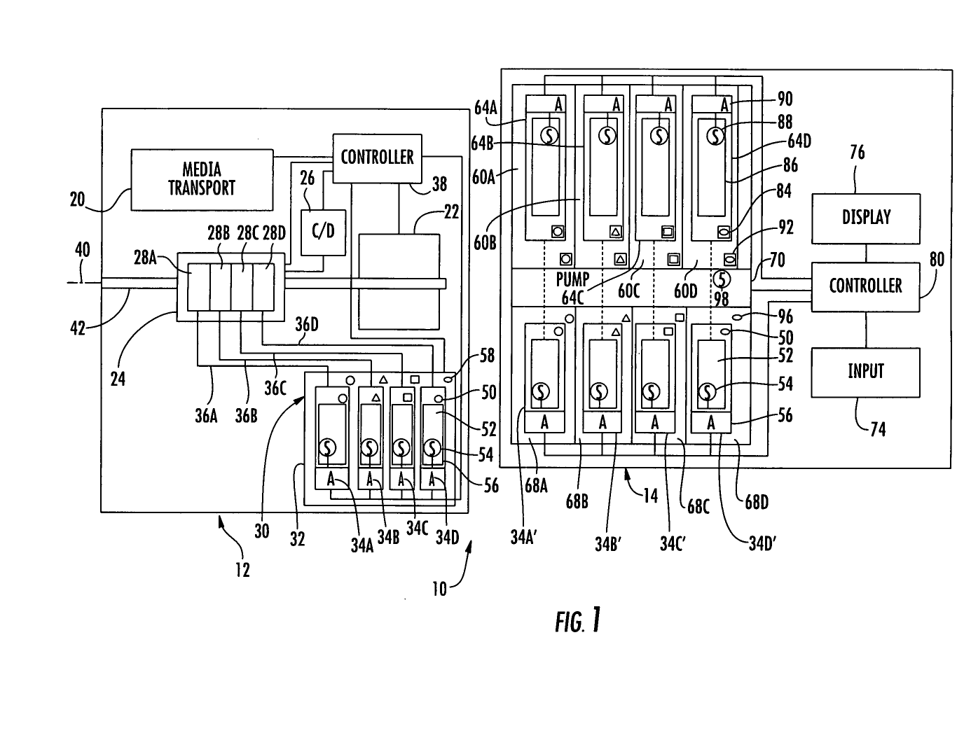

FIG. 1 schematically illustrates printing system 10 according to an example embodiment. Printing system 10 comprises a collection of devices configured to print or otherwise deposit fluid, such as ink, upon a print medium and to facilitate more convenient refilling of ink reservoirs used for printing in less time, with fewer errors and without substantially interrupting printing. Printing system 10 includes printer 12 and transfer station 14.

Printer 12 is configured to print fluid, such as ink, upon a print medium. Printer 12 includes media transport 20, service station 22, carriage 24, carriage drive 26, print cartridges 28A, 28B, 28C and 28D (collectively referred to as print cartridges 28), fluid delivery system 30 including supply station 32, supply cartridges 34A, 34B, 34C and 34D (collectively referred to as supply cartridges 34), fluid conduits 36A, 36B, 36C and 36D (collectively referred to as conduits 36) and controller 38. Media transport 20 comprises a device configured to move print media relative to print cartridges 28 to position print media during printing. Media transport 20 may comprise driven belts, webs, rollers and the like configured to fictionally or otherwise engage sheets or webs of print media to move such print media.

Service station 22 comprises that portion of printer 12 configured to service print cartridges 28. Service station 22 comprises presently or future developed devices configured to perform spitting, wiping and capping of print head nozzles associated with print cartridges 28. In other embodiments, service station 22 may be omitted.

Carriage 24 comprises one or more structures configured to support print cartridges 28 relative to a print medium being printed upon and to facilitate movement or scanning of print cartridges 28 along axis 40. In the particular example illustrated, carriage 24 removably receives print cartridges 28 and is guided along axis 40 by carriage rod 42. In other embodiments, carriage 24 may be movably support along axis 40 by other structures and may be fixedly or substantially permanently connected to print cartridges 28.

Carriage drive 26 comprises an actuator configured to move carriage 24 along axis 40. In one embodiment, carriage drive 26 comprises a motor (not shown) operably coupled to carriage 24 by one or more gears, belts, sprocket and the like (not shown) so as to linearly move carriage 24 along axis 40. In other embodiments where print cartridges 28 have a sufficient width, such as with a page-wide-array printer, carriage 24 and carriage drive 26 may be omitted.

Print cartridges 28 (sometimes referred to as pens) comprise individual devices configured to deposit or eject fluid, such as ink, onto a print medium as positioned by media transport 20. Print cartridges 28 each include one or more print heads (not shown) having nozzles through which the fluid is ejected. In one embodiment, print cartridges 28 each include local ink chambers (not shown) that supply fluid to the printheads of the associated cartridge 28. In the example illustrated, cartridges 28 are configured to eject different colors of ink. In one embodiment, cartridges 28A, 28B, 28C and 28D are configured to eject black, cyan, magenta and yellow colored inks, respectively. In other embodiments, printer may include greater or fewer number of such cartridges 28 and cartridges 28 may be configured to eject greater or fewer of such colors or alternative colors of ink or other fluids onto a print medium.

Fluid delivery system 30 comprises an off-axis fluid delivery system that supplies and delivers fluid, such as ink, to each of print cartridges 28. Station 32 comprises that portion of printer 12 configured to removably receive supply cartridges 34 and to interact with supply cartridges 34 so as to withdraw fluid from cartridges 34 and to move such withdrawn fluid through conduits 36 to cartridges 28. In one embodiment, station 32 may include a pump, such as a peristaltic pump. In other embodiments, station 32 may include other fluid withdrawing or pumping mechanisms.

Fluid supply cartridges 34 comprise structures configured to contain fluid or ink to be delivered to print cartridges 28. Cartridges 34 each include keying structure 50, reservoir 52, sensor 54 and acumen 56. Keying structure 50 is a projection or detent along an exterior of each cartridge 34 and having a shape or configuration associated with a particular fluid contained within the associated cartridge 34 and distinct from other structures 50 associated with other cartridges 34 containing other distinct fluids. Keying structure 50 is configured to mate or key with a corresponding opposite keying structure 58 associated with conduits 36 and station 32. Keying structures 50 and 58 reduce the likelihood of one of cartridges 34 being incorrectly connected to station 32 and fluidly connected to a wrong conduit 36. For example, in the example illustrated, cartridges 34A, 34B, 34C and 34D have circular, triangular, square and oval keying structures 50, respectively, which makes with corresponding circular, triangular, square and oval keying structures 58 of station 32. Keying structures 50 and 58 facilitate fluid connection of cartridges 34A, 34B, 34C, and 34D to fluid conduits 36A, 36B, 36C and 36D, respectively, and minimize or prevent other connection errors. In one embodiment, keying structures 50 may comprise projections while keying structures 58 comprise correspondingly shaped detents. In other embodiments, this relationship may be reversed. In other embodiments, keying structures 50 and/or 58 may be omitted.

Reservoirs 52 comprised volumes or chambers within cartridges 34 configured to contained fluid, such as ink. In the example illustrated, reservoirs 52 of cartridges 34A, 34B, 34C and 34D are configured to contain black, cyan, magenta and yellow colors of ink, respectively. In one embodiment, reservoir 52 may be flexible or collapsible. In other embodiments, reservoirs 52 may be rigid.

Sensors 54 comprise one or more sensing devices disposed within reservoirs 52 and configured to sense the fluid level and/or characteristics of fluid within reservoir 52. In one embodiment, sensors 54 comprised inductive coils configured to sense fluid levels. Sensors 54 provides signal representing the sensed characteristics or levels of fluid within reservoir 52 to acumen 56. In other embodiments, sensors 54 may be omitted.

Acumen 56 comprise memory stores structures configured to store information. In one embodiment, acumens 56 comprise memory storage structures configured to store data pertaining to the fluid or ink within reservoir 52. For example, in one embodiment, acumen 56 store data such as the current level of fluid within reservoirs 52, the type of fluid or ink within reservoir 52, the age of the fluid or ink within reservoir 52 and the like.

Controller 38 comprises one or more processing units configured to receive signals or feedback from media transport 20, service station 22, carriage 24, carriage drive 26, print cartridges 28, delivery station 32 and cartridges 34 and to generate control signals based upon such information. Such control signals direct the operation of media transport 20, carriage drive 26, print cartridges 28 and delivery station 32. For example, controller 38 may generate control signals directing media transport 20 to position a sheet of media relative to scan axis 40. Controller 38 may also generate control signals directing carriage drive 26 to scan or move carriage 24 and print cartridges 28 relative to the sheet of media. Controller 38 also generates control signals directing each of cartridges 28 to selectively eject fluid onto the print media. At appropriate times, controller 38 may generate control signals directing carriage drive 26 to move carriage 24 and print cartridges 28 to service station 22 for servicing. Controller 38 also generates control signals directing delivery station 32 to pump or supply ink or other fluid from reservoirs 52 through conduits 36 to print cartridges 28.

For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Controller 38 is not limited to any specific combination of hardware circuitry and software, nor to any particular source for the instructions executed by the processing unit.

At certain times, one or more of supply cartridges 34 may become empty or maybe sufficiently emptied such that cartridges 34 do not contain sufficient amounts of fluid or ink to complete a forthcoming printing job or run. Transfer station facilitates efficient and convenient replacement of an emptied or partially emptied supply cartridge 34 with another filled or more filled supply cartridge 34. Transfer station 14 includes source bays 60A, 60B, 60C and 60D (collectively referred to as bays 60), volume fluid supplies 64A, 64B, 64C and 64D (collectively referred to as fluid supplies 64), destination bays 68A, 68B, 68C and 68D (collectively referred to as bays 68), fluid supply replacement cartridges 34A′, 34B′, 34C′ and 34D′ (collectively referred to as replacement cartridges 34′), pump 70, input 74, display 76 and controller 80. Source bays 60 comprise locations configured to removably receive or be connected to volume supplies 64 for the transfer of fluid from supplies 64 by pump 70 to replacement cartridges 34′.

Volume supplies 64 comprise containers configured to store and supply fluid or ink to be transferred to replacement cartridges 34′. Volume supplies 64 may or may not be the same capacity or size as replacement cartridges 34′. Volume supplies 64 are configured to be removably received within source bays 60. Each volume supply 64 includes keying structure 84, sensor 88 and acumen 90. Keying structure 84 is a projection or detent along an exterior of each supply 64 and having a shape or configuration associated with a particular fluid contained within the associated cartridge 34′ and distinct from other structures 84 associated with other supplies 64 containing other distinct fluids. Keying structure 84 is configured to mate or key with a corresponding opposite keying structure 92. Keying structures 84 and 92 reduce the likelihood of one of supplies 64 being incorrectly connected to station 14 and fluidly connected to a wrong cartridge 34′. For example, supplies 64A, 64B, 64C and 64D have circular, triangular, square and oval keying structures 84, respectively, which mate with corresponding circular triangular, square and oval keying structures 92 of source bays 60. Keying structures 84 and 92 facilitate fluid connection of supplies 64A, 64B, 64C and 64D to source bays 60A, 60, 60C and 60D, respectively, and minimize or prevent other connection errors. In one embodiment, keying structures 84 may comprise projections while keying structures 92 comprise corresponding opposite shaped detents configured to receive such projections. In other embodiments, this relationship may be reversed. In other embodiments, keying structures 84 and/or 92 may be omitted.

Reservoirs 86 comprise volumes or chambers within supplies 64 configured to contain fluid, such as ink. In one embodiment, reservoirs 86 store a larger volume of or ink as compared to their counterpart reservoirs contained within replacement cartridges 34′. In one embodiment, each reservoir 86 may be flexible or collapsible. In other embodiments, reservoirs 86 may be uncompressible.

Sensors 88 comprise one or more sensing devices disposed within reservoirs 86 and configured to sense the fluid level and/or characteristics of fluid within reservoir 86. In one embodiment, sensors 88 comprise inductive coils configured to sense fluid levels. Sensors 88 provides signal representing the sensed characteristics or levels of fluid within reservoir 86 to acumen 90. In other embodiments, sensors 88 may be omitted.

Acumen 90 comprise memory stores structures configured to store information. In one embodiment, acumens 90 comprise memory storage structures configured to store data pertaining to the fluid or ink within reservoir 86. For example, in one embodiment, acumens 90 store data such as the current level of fluid within reservoirs 86, the type of fluid or ink within reservoir 86, the age of the fluid or ink within reservoir 86 and the like.

Destination bays 68 comprise locations configured to removably receive or be removably connected to replacement cartridges 34′ and to facilitate fluid connection between replacement cartridges 34′ and pump 70 and supplies 64. In one embodiment, destination bays 68 comprise depressions, channels or cavities into which replacement cartridges 34′ may be inserted. In other embodiments, destination bays 68 may alternatively project into corresponding cavities in replacement cartridges 34′.

In the example embodiment illustrated, destination bays 68 each include a keying structure 96 configured to mate with a corresponding keying structure 50 of one of replacement cartridges 34′ or cartridges 34. Keying structure 96 is a projection or detent having a shape or configuration associated with a particular fluid contained within the associated cartridge 34 that the particular bay 68 is designated to receive. Keying structure 96 is configured to mate or key with a corresponding opposite keying structure 50. Keying structures 96 and 50 reduce the likelihood of one of replacement cartridges 34′ being incorrectly connected to station 14 and fluidly connected to a wrong destination bay 68 and an incorrect volume supply 64. For example, in the example illustrated, destination bays 68A, 68B, 68C and 68D have circular, triangular, square and oval keying structures 96, respectively, which may with corresponding circular, triangular, square and oval keying structures 50 of replacement cartridges 34′. In one embodiment, keying structures 96 may comprise projections while keying structures 50 comprise oppositely shaped detents. In other embodiments, this relationship may be reversed. In other embodiments, keying structures 96 and/or 50 may be omitted.

Replacement cartridges 34′ or substantially identical to cartridges 34. In particular, replacement cartridges 34′ are configured to be interchangeable with cartridges 34. For example, replacement cartridges 34A′, 34B′, 34C′ and 34D′ are identical to cartridges 34A, 34B, 34C and 34D, respectively, in their structure and in their contained fluid. Replacement cartridges 34A′, 34B′, 34C′ and 34D′ are configured to receive and contained black, cyan, magenta and yellow ink similar to cartridges 34A, 34B, 34C and 34D, respectively.

Pump 70 comprises an electromechanical device configured to promote flow of fluid, such as from volume supplies 64 connected to source bays 60 to corresponding replacement cartridges 34′ connected to destination bays 68. In one embodiment, pump 70 may comprise a peristaltic pump. And yet other embodiments, pump 70 may be configured to interact with diaphragms or other structures associated with one or both of supplies 64 and cartridges 34′ to facilitate fluid flow. In one embodiment, pump 70 includes one or more sensors 98 (one of which are shown) configured to sense or detect the rate at which fluid is pumped. In other embodiments, sensor 98 may be omitted.

Input 74 comprises one or more input devices configured to facilitate entry or input of commands or instructions by a user or other external input device to transfer station 14. For example, input 74 may comprise a keyboard, mouse, microphone with appropriate voice recognition software, touchpad, touchscreen, dial, buttons and the like. Input 74 permits a user to adjust a rate at which fluid is transferred by pump 70, to disable or selectively enable transfer of fluid from particular source bays 60 to particular destination bays 68 or to request information regarding fluid contained within supplies 64 and cartridges 34′ or other information such as an estimated time of completion for the transfer of fluid to particular selected cartridges 34′. In other embodiments, input 74 may be omitted.

Display 76 comprises one or more devices to configured to provide information or data to a user. In one embodiment, display 76 may comprise a screen, such as an LCD screen. In other embalmed come display 76 may comprise one of more rows of selectively actuatable lights, such as light emitting diodes. In still other embodiments, display 76 may include audio generating components configured to generate sounds, such as warning beeps communicating certain information. In the embodiment illustrated, display 76 displays information including, but not limited to, flow rate, the level of supplies 64, current fill level of replacement cartridges 34′, data regarding the fluid within supplies 64 such as the type of fluid or the age of such fluid, data regarding the fluid within replacement cartridges 34′ such as the type of fluid or the age of such fluid, and estimated completion time for filling one or more of cartridges 34′ or the elapsed time since filling was initiated for one or more of replacement cartridges 34′. In other embodiments, display 76 may be configured to display greater or lesser amounts of such data.

Controller 80 comprises one or more processing units configured to receive and analyze data received from sensors 54, 88, acumens 56, 90 and sensor 98 of pump 70. Controller 80 is further configured to receive input commands or instructions from input 74. Based upon such data and commands, controller 80 is configured to generate control signals adjusting operation of pump 70, writing in storing data to acumen 56 and 90 and directing display 76 to communicate information to a user.

Because station 14 permits replacement cartridges 34′ to be refilled while disconnected from supply station 32 and while disconnected from the print heads of print cartridges 28, printer 12 may be supplied with an adequate volume of ink without prolonged delays during refilling. Printer 12 may continuously print but for the time to exchange one of cartridges 34 for one of replacement cartridges 34′. Because station 14 includes multiple source bays 60 and destination bays 68, station 14 may accommodate multiple colors or cartridges at the same time. Keying structures 92 and 96 of station 14 reduce the likelihood of incorrect connections between supplies 60 and cartridges 34′ containing different fluids. At the same time, display 76 reduces uncertainty by communicating to a user various pieces of information regarding the refilling of replacement cartridges 34′ such as the estimated completion time, the current flow rate, the current fluid levels and the like.

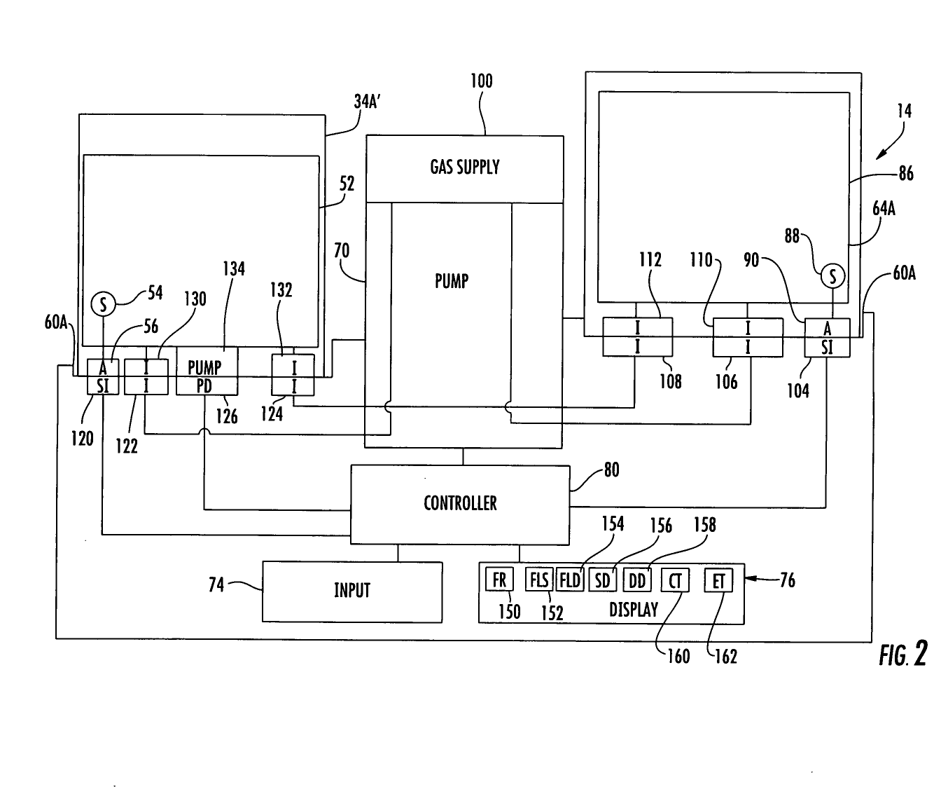

FIG. 2 schematically illustrates portions of station 14 in more detail. As shown by FIG. 2, station 14 additionally includes gas supply 100, source bays 60 each additionally include signal interconnects 104, fluid interconnect 106 and fluid interconnect 108, volume supplies 64 each additionally include fluid interconnect 110 and fluid interconnect 112, destination bays 68 each additionally include signal interconnects 120, fluid interconnect 122, fluid connect 124 and pump drive 126, and replacement cartridges 34′, as well as cartridges 34, each additionally include fluid interconnect 130, fluid interconnect 132 and pump 134. Gas supply 100 comprises a supply of a gas under pressure configured to be selectively delivered or pumped into one or both of supplies 64 or replacement cartridges 34′. By pumping gas under pressure into supply 64, the transfer of fluid from supply 64 may be facilitated. According to one embodiment, supply 100 may also be used to flush existing gas or air within replacement cartridge 34′ to reduce the occurrence of bubbles and the like in the fluid of cartridge 34′. For example, the gas supply 100 may supply carbon dioxide which may dissolve in some inks in contrast to air. In other embodiments, gas supply 100 may be omitted.

Signal interconnect 104 comprises one or more electrical contacts configured to contact corresponding electrical contacts of acumen 90 when the corresponding supply 64 is connected to an appropriate bay 60. Signal interconnect 104 transfers electrical signals between acumen 90 and controller 80. Controller 80 reads information from acumen 90 and may write data to acumen 90 via interconnect 104.

Fluid interconnect 106 cooperates with fluid interconnect 110 to provide fluid communication between reservoir 86 and gas supply 100. Interconnects 106 and 110 each include appropriate check valve mechanisms such that interconnects 106 and 110 or closed until inter-engagement between interconnects 106 and 110. In those embodiments which gas supply 100 is omitted, interconnects 106 and 110 may also be omitted.

Fluid interconnects 108 and 112 cooperate with one another to provide fluid communication between reservoir 86, pump 70 and reservoir 52 of replacement cartridge 34′. Like the fluid interconnects 106 and 110, fluid interconnects 108 and 112 each include check valve mechanisms configured to automatically include or close until interconnects 108 and 112 are brought into engagement with one another such as when supply 64 is positioned within bay 60.

Signal interconnect 120 is similar to signal interconnect 104 in that signal interconnect 120 comprises one or more electrical contacts configured to make electrical connection with acumen 56 when replacement cartridge 34′ is connected to destination bay 68. Signal interconnect 120 transfers electrical signals between acumen 56 in controller 80. Controller 80 reads information from acumen 56 and may write data to acumen 56 via interconnect 120.

Fluid interconnect 122 cooperates with fluid interconnect 130 to provide fluid communication or flow between reservoir 52 and gas supply 100. Interconnects 122 and 130 each include appropriate check valve mechanisms which results in such interconnects being closed until their inter-engagement. In those embodiments in which gas supply 100 is omitted, interconnects 122 and 130 may also be omitted.

Fluid interconnects 124 and 132 cooperate with one another to provide fluid communication between reservoir 86, pump 70 and reservoir 52 of replacement cartridge 34′. Like the fluid interconnects 122 and 130, fluid interconnects on 24 and 132 each include check valve arrangements configured to automatically occlude or close until interconnects 124 and 132 are brought into engagement with one another such as when replacement cartridge 34′ is connected to bay 68.

In the particular embodiment illustrated, interconnects 108 and 112 each include a valve configured to automatically open in response to positioning of supply 64 into bay 60A. Upon withdrawal of supply 64 from bay 60A, the valves of interconnects 108 and 112 automatically close. In a similar manner, interconnects 124 and 132 each include a valve configured to automatically open in response to positioning of cartridge 34′ into bay 68A. Upon withdrawal of cartridge 34′ from bay 68A, the valves of interconnects 124 and 132 automatically close. As a result, connection time and complexity is reduced.

Pump drive 126 comprises an actuator configured to apply force to pump 134 of cartridge 34A′ connected to bay 68. Pump 134 comprises a diaphragm configured to transfer received force to reservoir 52 to reduce the volume of reservoir 52 so as to discharge fluid from reservoir 52 through fluid interconnects 132 and 124. In one embodiment, pump drive 126 comprises a motor operably connected to one of more cams (not shown) configured to apply forced to the diaphragm of pump 134. In yet other embodiments, pump drive 126 and pump 134 may have other configurations or may be omitted, such as where pump 70 sufficiently withdraws fluid from reservoir 52.

As further shown by FIG. 2, display 76 includes display portions 150, 152, 154, 156, 158, 160 and 162. Display portion 150 comprises that portion of display 76 configure to present information regarding the current flow or pumping rate provided by pump 70 between one or more source supply and destination cartridge pairs. As a result, a user may assess whether station 14 is malfunctioning or whether the pumping rate should be adjusted.

Portions 152 and 154 present information to a user regarding the current fluid level within one or more supplies 64 and one or more destination replaceable cartridges 34′, respectively. As result, display 76 enables a user to determine whether a particular supply 64 is adequate to complete refilling of a paired replaceable cartridge 34′ or whether a particular replaceable cartridge 34′ being filled is officially filled for an intended printing job.

Portions 156 and 158 display information regarding the particular fluids contained within supply 64 and cartridge 34′, respectively. As a result, display 76 enables a user to verify that appropriate fluids or inks are being transferred or alternatively enables a user to determine the age or quality of the ink or fluid being transferred and to make adjustments.

Portion 160 present information regarding an estimated completion time for the filling of cartridge 34′ based upon the current flow rate provided by pump 70. Such information may be communicated as the remaining number of minutes or hours until filling is completed or as the time that such filling is expected to be completed. In one embodiment, may be configured to request input via input 74 from a user asked to the degree or percent to which it particular cartridge 34′ is to be filled. In such an embodiment, controller 80 may generate control signals directing pump 70 to cease pumping fluid to the particular cartridge 34′ when the particular cartridge 34′ is filled to the input level. In such an embodiment, portion 160 may be configured to display the time remaining or the estimated time at which the desire to fill percentage will be achieved. As a result, a user may return to Station 14 at or slightly after the time at which desired filling is completed rather than continuously monitoring station 14.

Portion 162 of display 76 is configured to present information to a user regarding the amount of time elapsed since the initiation of the transfer of fluid from one or more of supply 64 to one or more of selected cartridges 34′. As a result, display 76 enables a user to assess whether Station 14 is properly functioning. In other embodiments, display 76 may include a greater or fewer of such portions for presenting information to a user. In one embodiment, customized information is displayed by display 76 and the arrangement of such information is based upon input to received via input 74. For example, in some embodiments, display 76 may comprise a screen, wherein portions of the screen display different information (portions 150-162). The layout of the presented screen may be varied based upon input provided by user via input 74. In other embodiments, one or more of portions 150-162 may alternatively comprise light emitting diodes, rows of light emitting diodes or other mechanisms for communicating or presenting information to a user. In some of embodiments, display 76 may alternatively be omitted.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a first bay configured to removably receive a first fluid supply;
a second bay configured to removably receive a second fluid supply for an inkjet printhead while the second fluid supply is disconnected from any printhead; and
a pump configured to transfer fluid from the first fluid supply to the second fluid supply.

2. The apparatus of claim 1, further comprising at least one sensor configured to sense at least one of fluid flow from the first supply to the second supply, a fluid level within the first supply, a fluid level within the second supply and a type of fluid within the first supply.

3. The apparatus of claim 1 further comprising a display configured to indicate at least one of flow rate from the first supply to the second supply, a fluid level of the first supply, a fluid level of the second supply, estimated time until filling of the second supply, type of fluid in the first supply or type of fluid in the second supply.

4. The apparatus of claim 1 further comprising a first keying structure in the first bay and configured to mate with a corresponding keying structure associated with the first fluid supply.

5. The apparatus of claim 4 further comprising a second keying structure in the second bay and configured to mate with a corresponding keying structure associated with the second fluid supply.

6. The apparatus of claim 1 further comprising a plurality of source bays including the first bay and a plurality of destination bays including the second bay.

7. The apparatus of claim 6, wherein at least two of the destination bays include different keying structures configured to mate with corresponding different keying structures associated with different second fluid supplies.

8. An apparatus comprising:
a first bay configured to removably receive a first fluid supply;
a second bay configured to removably receive a second fluid supply for an inkjet printhead;
a pump configured to transfer fluid from the first supply to the second supply; and
at least one sensor configured to sense at least one of fluid flow from the first supply to the second supply, a fluid level within the first supply, a fluid level within the second supply and a type of fluid within the first supply.

9. The apparatus of claim 8, wherein the second bay is configured to removably receive the second fluid supply while the second fluid supply is disconnected from any printhead.

10. The apparatus of claim 8 further comprising a first keying structure in the first bay and configured to mate with a corresponding keying structure associated with the first fluid supply.

11. The apparatus of claim 10 further comprising a second keying structure in the second bay and configured to mate with a corresponding keying structure associated with the second fluid supply.

12. The apparatus of claim 8 further comprising a plurality of source bays including the first bay and a plurality of destination bays including the second bay.

13. The apparatus of claim 12, wherein at least two of the destination bays include different keying structures configured to mate with corresponding different keying structures associated with different second fluid supplies.

14. A method comprising:
removably positioning a first fluid supply in a first bay of a transfer station to actuate a valve to fluidly connect the first supply to the transfer station;
removably positioning a second fluid supply in a second bay of the transfer station to actuate a valve to fluidly connect the second fluid supply to the transfer station;
transferring fluid from the first fluid supply to the second fluid supply with the transfer station;
disconnecting the second fluid supply from the transfer station; and
connecting the second fluid supply to an inkjet printhead.

15. The method of claim 14 further comprising:
sensing at least one of fluid flow from the first supply to the second supply, a fluid level within the first supply, a fluid level within the second supply and a type of fluid within the first supply; and
displaying at least one of fluid flow rate from the first supply to the second supply, a fluid level within the first supply, a fluid level within the second supply and a type of fluid within the first supply.

16. The method of claim 14 further comprising determining an estimated time for filling the second supply to a predetermined level.

17. The method of claim 16 further comprising displaying the estimated time for filling the second supply.

18. The method of claim 14, wherein transferring comprises pumping fluid from the first fluid supply to the second fluid supply.

19. The method of claim 14 further comprising sensing at least one of fluid flow from the first supply to the second supply, a fluid level within the first supply, a fluid level within the second supply and a type of fluid within the first supply.

20. The method of claim 14 further comprising connecting the second fluid supply to the transfer station by mating a first keying structure of the second fluid supply to a second corresponding keying structure in a bay of the transfer station.
